(19) United States
(12) Patent Application Publication
(10) Pub. No.: US 2015/0343628 A1
(43) Pub. Date: Dec. 3, 2015

(54) Transferrable Template Tool

(71) Applicant: Henry Moreland, Tulsa, OK (US)

(72) Inventor: Henry Moreland, Tulsa, OK (US)

(21) Appl. No.: 14/724,970

(22) Filed: May 29, 2015

Related U.S. Application Data
(60) Provisional application No. 62/004,373, filed on May 29, 2014.

(51) Int. Cl. B25H 7/00

(52) U.S. Cl. CPC B25H 7/005; B25H 7/00

(57) ABSTRACT

A template tool is provided for locating apertures on a work surface. The template is one that is assemblable over an existing installation, such as a plumbing installation, and one that is transferrable onto a flat work surface, such as a drywall panel. The template is assembled using two or more elongated, substantially flat and rectangular fixture template members that overlap one another and affix together. Each template member includes an elongated channel, whereby the channels of each pair of template members are overlapped over a point of interest, such as a pipe or water valve location. Several template members are overlapped to locate each point of interest relative to each other along a common plane, whereafter the assembled template is transferred to a work surface to be marked for cutting operations. Also provided are smaller templates affixable to the rectangular members for specific, multi-apertured assemblies, including faucets and spigots.

### CROSS REFERENCE TO RELATED APPLICATION

This application claims the benefit of U.S. Provisional Application No. 62/004,373 filed on May 29, 2014, entitled “Plumbing Pipe Templates.” The above identified patent application is herein incorporated by reference in its entirety to provide continuity of disclosure.

### BACKGROUND OF THE INVENTION

### Field of the Invention

The present invention relates to template tools and methods of transferring a pattern from an installation location to a flat work piece when modifying the work piece to match the pattern. More specifically, a template tool is provided that can be used to locate points of interest along an installation, such as a plumbing installation, whereafter the points of interest can be transferred without a tape measure to a work piece. Once the points of interest are located on the work piece, cut-outs can be created in the correct spatial location and the work piece can be placed over the installation location.

Measuring the location of pipes, outlets, and other fixtures during a plumbing installation generally involves use of a tape measure and a temporary template to ensure fitment of a cover panel or drywall panel thereover. The installer must measure the distance between the points of interest and then transfer the relative measurements to a drywall surface, or to an intermediate template that is used to verify the measurements. This process is prone to errors, requires time and skill, and generates waste in the form of templates that are used once and then discarded. When installing a panel over a plumbing installation with several pipes or outlets, measuring and remeasuring slows down the installation.

The present invention relates to a template tool that can be reused and one that does not require measurements using a tape measure tool. Specifically, the tool comprises an assembly of template members that are affixable together in a perpendicular and stacked relationship, whereby the template members have channels that are overlapped over various points of interest to be transferred and marked on a work piece (e.g. a drywall panel or the like). During a plumbing installation, once the pipes or outlets are installed, the template tool can be placed over each and used to mark their relative location, while the ends of the template members align with the outer extent of the panel to be placed thereover. The created template is transferred to the work piece and the pattern is marked, all without using a tape measure or using a disposable template.

The present invention is ideally suited for plumbing applications; however the specification and description of the invention should be interpreted as limited only to plumbing applications. The present invention provides a general purpose template tool that can be used to locate points of interest using assemblable template members that affix to one another. The template is then transferred to a work surface or work piece for locating the points of interest on the same. The present invention can be used in a wide array of environments and for several different applications, not limited to plumbing installation.

### SUMMARY OF THE INVENTION

The following summary is intended solely for the benefit of the reader and is not intended to be limiting in any way. The present invention provides a new template tool that can be utilized for transferring points of interest and their relative location from an installation and to a work piece for locating the points of interest on the work piece without using a tape measure or disposable template member.

It is an object of the present invention to provide an assemblable template tool that can be transferred onto a work surface that comprises at least two template members with a substantially flat cross section such that the template members can be stacked over each other and formed into a pattern to replicate the location of points of interest to be transferred from one location and onto a flat work surface.

Another object of the present invention to provide an assemblable template tool that comprises an assembly of individual template members, each template member having an elongated length, a first end, a second end, and an elongated, substantially rectangular slot disposed along the length thereof.

Another object of the present invention to provide an assemblable template tool, whereby each template member further comprises an upper surface and a lower surface. The upper surface of each template member comprising a first fastener thereon, while the lower surface of each template member comprising a second fastener thereon. The fasteners are complimentary to each other to removably affix together when placed in contact.

Another object of the present invention to provide an assemblable template tool, whereby each template member further comprises a substantially flat cross section such that the template members can be stacked over each other, and wherein the elongated slots of the templates form a substantially rectangular hole when two template members are stacked and orientated perpendicular to each other over a point of interest location to be transferred by the template tool.

Another object of the present invention to provide an assemblable template tool, whereby each template member further comprising a pair of vertical template members and a pair of horizontal template members.

Another object of the present invention to provide an assemblable template tool, whereby fasteners are one of a hook and loop fastener connection or a magnetic strip and ferric surface attachment.

Another object of the present invention to provide an assemblable template tool that further comprises a rectangular fixture template having one or more apertures therethrough, whereby the fixture template is adapted to be placed against the upper surface of one of the elongated template members and over the elongated slot thereof to market a fixture location with a specific aperture pattern

Another object of the present invention to provide an assemblable template tool that comprises a method of use in which two or more template members are used to locate points of interest. The template members are overlapped and connected using the complimentary fasteners such that the elongated channel of each template member overlaps and form an aperture over the points of interest. Once the template members are connected to locate of the points of interest, the assembled template is transferred to a work surface for locating the points of interest on the work surface using the overlapping channel locations.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead view of the template tool in an assembled state, whereby the template members are overlapping one another to form apertures that locate points of interest, as well as a fixture template secured to the template members for locating a specific style fixture.

FIG. 2 shows a perspective view of an individual template member.

FIG. 3 shows a pair of template members being overlapped and secured over a point of interest—in this case a pipe location.

FIG. 4 shows a close-up view of the fixture template secured along the upper surface of an elongated template member.

FIG. 5 shows another view of the assembled template after being transferred to a work surface, whereby the points of interest are located on the work surface.

### DETAILED DESCRIPTION OF THE INVENTION

Reference is made herein to the attached drawings. Like reference numerals are used throughout the drawings to depict like or similar elements of the assemblable template tool of the present invention. For the purposes of presenting a brief and clear description of the present invention, the preferred embodiment will be discussed as used for locating points of interest and for transferring the relative locations of each point to a work piece or flat work surface and form marking the locations. The figures are intended for representative purposes only and should not be considered to be limiting in any respect.

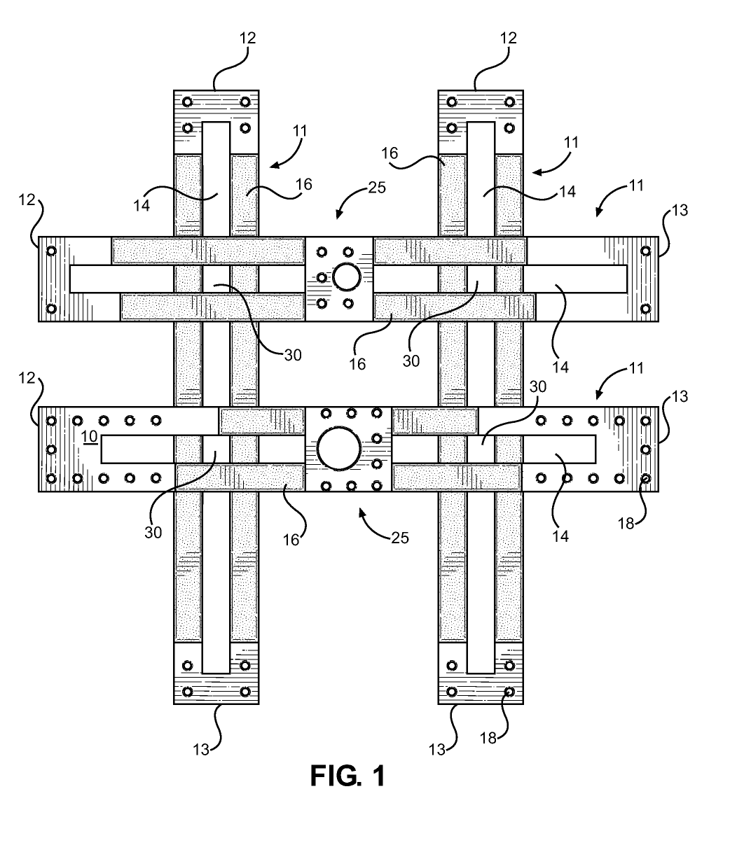

Referring now to FIG. 1, there is shown an assembled view of the template tool of the present invention. The present invention provides a means to create a temporary and reusable template over pipes, outlets, apertures, or other points of interest and providing the ability to transfer the location of those points of interest onto a flat work surface. The present invention is useful in many applications, including plumbing and electrical installations. The location of various pipes or junctions can be marked on drywall or along another work surface, whereafter cutouts can be created at the locations to accommodate the points of interest and create clearance therefor.

The template tool of the present invention comprises two or more elongated template members 11 that are overlapped and connected over a point of interest to mark the point and use the template members to transfer the location to a work surface. The template members 11 comprise elongated, substantially flat and thin lengths with a first end 12, a second end 13, and an elongated slot 14 disposed along the length of each. The members 11 are rectangular and the slot 14 extends substantially the entire length of the member. The template members 11 are overlapped such that the slots 14 of each align over a point of interest, whereby several template members can be overlapped in a crisscross pattern to mark a specific point layout to be transferred. This is useful when marking hole or pipe locations, whereby the slots 14 are aligned with the locations and the slot overlaps mark the locations when the template assembly is transferred to drywall or another work surface. Aligned cutouts can then be created without intermediate measurement of the cutout locations.

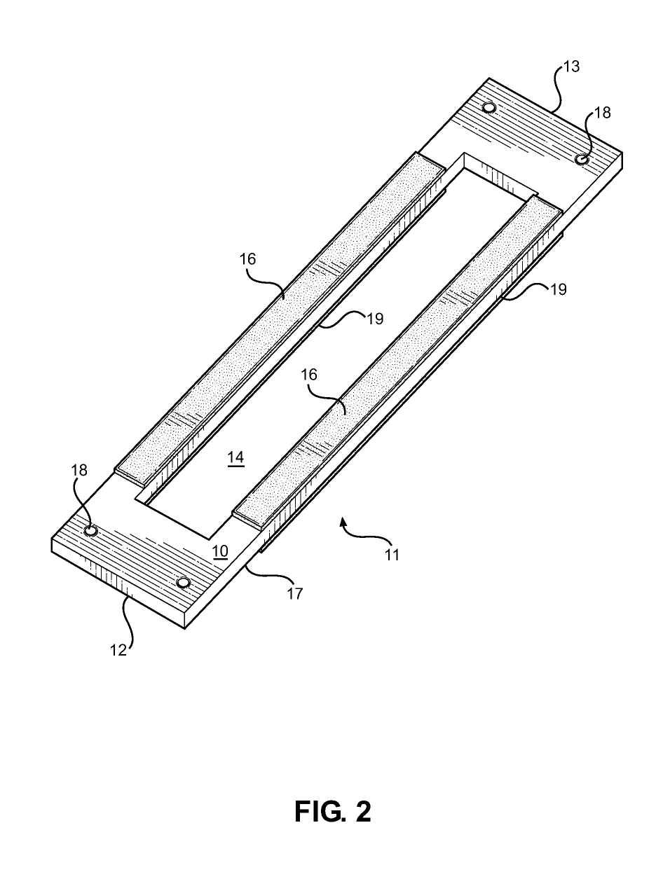

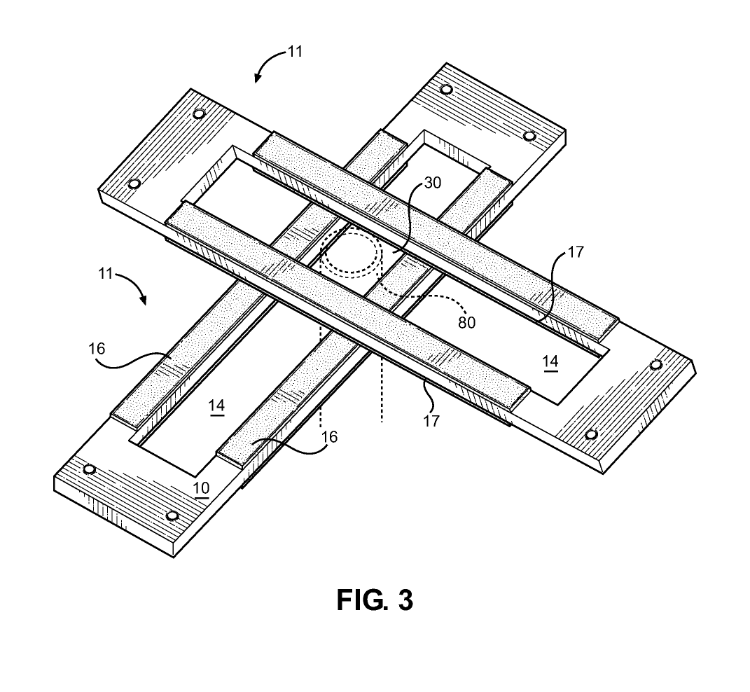

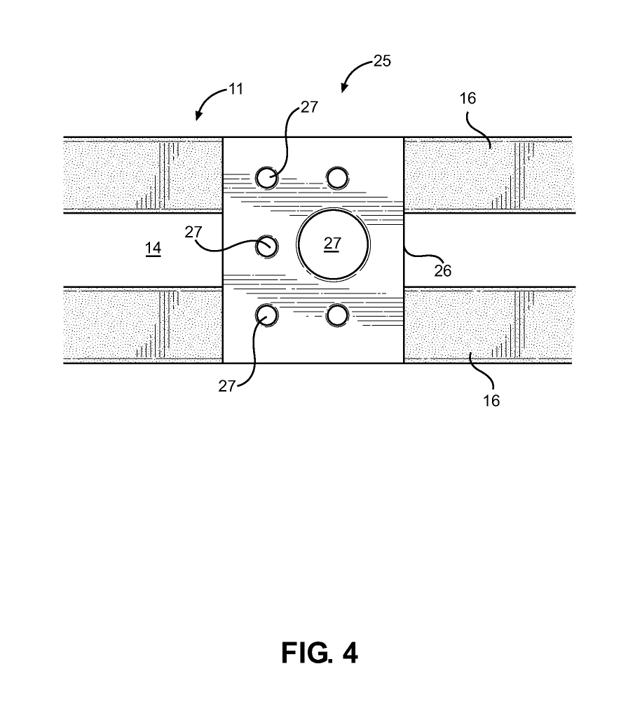

Referring to FIGS. 1 through 5, each of the template members has an upper surface 10, a lower surface 17, a first fastener 16, and a second fastener 19. The first 16 and second 19 fasteners are complimentary to each other, in that the first fastener 16 secures to the second fastener 19 when the two are in contact with one another. The fasteners create a secure bond between the upper and lower surfaces of each template member, whereby the connection is nonpermanent and is a removable attachment. Contemplated fasteners include any temporary fastener suitable for this purpose. Exemplary embodiments include hook and loop fastener material, as well as a magnetic strip and corresponding ferric material strip fastener connection. These are considered nonlimiting examples only.

The template members 11 are used to locate the points of interest and for transferring the locations thereof to a work surface. This is primarily accomplished by arranging one or more of the template members 11 in a vertical condition with their slots 14 aligned with the points to be captured. Thereafter, one or more template members 11 are placed horizontally across the same points of interest, whereby the channels 14 of two template members 11 overlap to form a small, rectangular point location 30. The point locations 30 can receive pipes 80 therethrough or be aligned with other items to be referenced in the formation of the template. The template members 11 are overlapped and pressed together, whereby the fasteners secure the members together r in a defined crisscross pattern. This pattern can then be removed from the work area while in an assembled state and placed onto a work surface for transferring the points of interest thereonto, whereby the point locations 30 are used as reference locations. The ends of the template members may further be marked or placed such that the outer extents of the work piece can be marked prior to placing the work piece against the location upon which the template was made. The ends of the template members may further have apertures 18 therethrough for securing the template members or for marking locations on the work surface.

Referring to FIGS. 1 through 4, there is also shown the fixture template 25 that is used to mark specific fixtures in a desired location along the template members 11. The fixture template 25 comprises a small, rectangular and thin template member that is pressed against the elongated template members 11 and fastened thereto. The lower surface 26 of the fixture template 25 includes a corresponding fastener to secure to the upper surface fastener 16 of the template members 11. The fixture template 25 comprises a plurality of apertures 27 that are unique to a specific fixture. These may include a main pipe location, as well as secondary apertures for vent locations and the like. The pattern of apertures 27 on the fixture template 25 is unique to the specific fixture being installed.

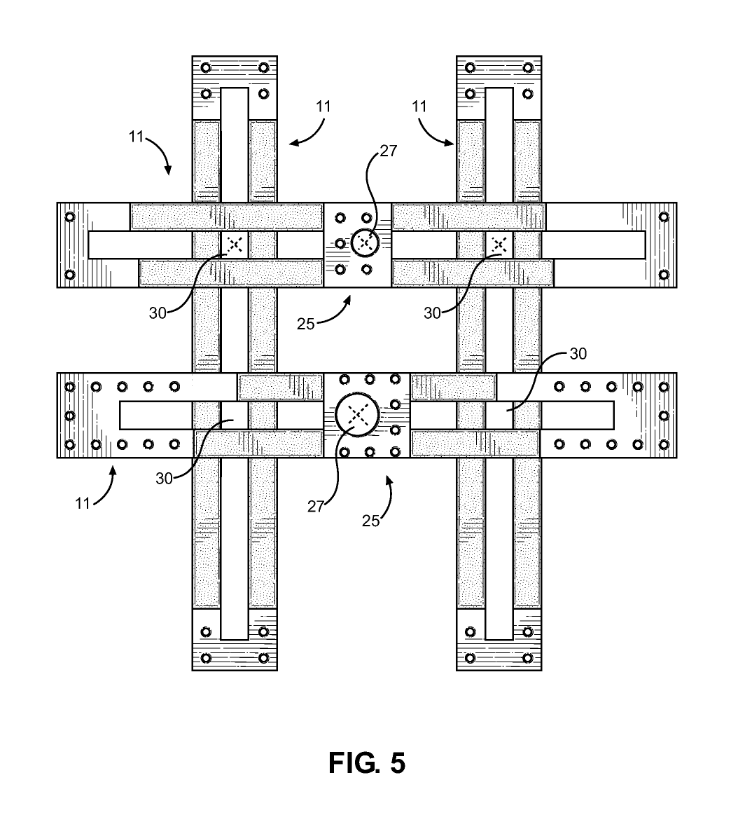

Referring to FIG. 5, there is shown a view of the template tool being used to mark locations on a flat work surface after being transferred from the work area to the work surface. In use, the template tool is used for spatially locating points of interest, creating a template, and for transferring the template onto a substantially flat work surface without using a tape measure tool. Two or more template members are used to locate points of interest in a work area, whereby the template members are overlapped and secured together using the fasteners provided thereon. Once fastened, the formed assembly can be removed from the work area and placed against a flat work surface to transfer the points of interest thereto. The points of interest can then be marked on the work piece for subsequent operations, whereafter the work surface be placed in the work area and the points of interest align transferred thereonto align with the points of interest on the work area.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An assemblable template that can be transferred onto a work surface, comprising:
at least two template members, each template member having an elongated length, a first end, a second end, and an elongated slot disposed along the length thereof;
each template member further comprises an upper surface and a lower surface;
the upper surface of each template member comprising a first fastener thereon;
the lower surface of each template member comprising a second fastener thereon that is complimentary to the first fastener such that the first fastener and the second fastener removably affix to one another when in contact;
each of the template members having a substantially flat cross section such that the template members can be stacked over each other;
wherein the elongated slots of the templates form a substantially rectangular hole when two template members are stacked and orientated perpendicular to each other.

2. The assemblable template of claim 1, wherein the at least two template members further comprise a pair of vertical template members and a pair of horizontal template members.

3. The assemblable template of claim 1, wherein the template members further comprises a substantially rectangular shape.

4. The assemblable template of claim 1, wherein the first fastener and the second fastener comprise complimentary hook and loop fasteners.

5. The assemblable template of claim 1, wherein the first fastener comprises a magnetic strip and the second fastener further comprises a ferric surface adapted to be magnetically attracted to the magnetic strip.

6. The assemblable template of claim 1, further comprising:
a rectangular fixture template having one or more aperture therethrough;
the rectangular fixture template comprising a lower surface with one of the first fastener or the second fastener thereon;
wherein the rectangular fixture template is adapted to be placed against the upper surface of one of template members and over the elongated slot thereof.

7. A method of spatially locating points of interest, creating a template, and transferring the template onto a substantially flat work surface, comprising the steps of:
using two or more template members to locate points of interest, the template members comprising:
an elongated length, a first end, a second end, and an elongated slot disposed along the length thereof;
each template member further comprises an upper surface and a lower surface;
the upper surface of each template member comprising a first fastener thereon;
the lower surface of each template member comprising a second fastener thereon that is complimentary to the first fastener such that the first fastener and the second fastener removably affix to one another when in contact;
each of the template members having a substantially flat cross section such that the template members can be stacked over each other;
overlapping the two or more templates such that the elongated channels of each overlap and form apertures over the points of interest;
securing the two or more templates together using the first fastener and the second fastener;
transferring the two or more templates to a work surface after being secured;
locating the points of interest on the work surface by locating the apertures.

8. The method of claim 7, further comprising:
using a rectangular fixture template to mark additional points of interest along one of the template members, the rectangular fixture template comprising:
rectangular fixture template comprising a lower surface with one of the first fastener or the second fastener thereon;
one or more apertures therethrough; and
wherein the rectangular fixture template is adapted to be placed against the upper surface of one of template members and over the elongated slot thereof.
